(19) United States
(12) Patent Application Publication
(10) Pub. No.: US 2024/0405704 A1
(43) Pub. Date: Dec. 5, 2024

(54) METHOD OF REDUCING VIBRATIONS IN AN ELECTRIC MOTOR

(71) Applicant: ABB Schweiz AG, Baden (CH)

(72) Inventors: Lennart Harnefors, Västerås (SE); Omer Ikram Ul Haq, Surahammar (SE); Sjoerd Bosga, Västerås (SE)

(21) Appl. No.: 18/674,130

(22) Filed: May 24, 2024

(30) Foreign Application Priority Data
Jun. 1, 2023 (EP) 23176831.8

(51) Int. Cl. H02P 23/04

(52) U.S. Cl. CPC H02P 23/04; H02P 2205/05

(57) ABSTRACT

A method of reducing vibrations in an electric motor including a rotor and a stator, by means of an active vibration controller, AVC, the method includes: a) determining whether one of an angular rotational speed of the rotor and an angular stator frequency multiplied by two is within a critical range including a mechanical resonance frequency of a motor assembly including the electric motor and its load, b) i) setting an oscillating incremental torque angular frequency of the AVC to the angular rotational speed of the rotor if the angular rotational speed of the rotor is within the critical range, or ii) setting the oscillating incremental torque angular frequency to the angular stator frequency multiplied by two if the angular stator frequency multiplied by two is within the critical range, iii) generating an oscillating incremental torque reference using the AVC with the oscillating incremental torque angular frequency set in step b i) or b ii), and iv) controlling the electric motor based on a sum of the oscillating incremental torque reference and an electrical torque reference; or c) i) deactivating the AVC if the angular rotational speed of the rotor and the angular stator frequency multiplied by two is outside the critical range, and ii) controlling the electric motor based on the electrical torque reference.

### TECHNICAL FIELD

The present disclosure generally relates to electric motors.

### BACKGROUND

Severe vibrations of the foundation of an electric motor occur when an electrical motor operates at natural frequencies of the mechanical body, i.e., of the entire motor assembly, including the stator, the rotor, motor end plates, and connected load if any, etc. Traditionally, this problem has been resolved by making design modifications to the mechanical assembly to alter the natural frequency modes. This involves design modifications to the machine itself, such as modifications of the mounting assembly allowing the machine to be operated at speeds below the natural frequencies, i.e. the critical speed is never reached.

Continuous operation at or close to the critical speed is not feasible. If operation above the critical speed is required, during acceleration and deceleration of motor, there are instances when the critical speed is passed, temporarily resulting in large vibrations. These can be harmful; hence passage of the critical speed must be made as quickly as possible, which limits the operational range of the machine.

### SUMMARY

Thus, in view of the above an object of the present disclosure is to provide a method which solves or at least mitigates the problems of the prior art.

There is hence according to a first aspect of the present disclosure provided a method of reducing vibrations in an electric motor comprising a rotor and a stator, by means of an active vibration controller, AVC, the method comprising: a) determining whether one of an angular rotational speed of the rotor and an angular stator frequency multiplied by two is within a critical range comprising a mechanical resonance frequency of a motor assembly comprising the electric motor and its load, b) i) setting an oscillating incremental torque angular frequency of the AVC to the angular rotational speed of the rotor if the angular rotational speed of the rotor is within the critical range, or ii) setting the oscillating incremental torque angular frequency to the angular stator frequency multiplied by two if the angular stator frequency multiplied by two is within the critical range, iii) generating an oscillating incremental torque reference using the AVC with the oscillating incremental torque angular frequency set in step b i) or b ii), and iv) controlling the electric motor based on a sum of the oscillating incremental torque reference and an electrical torque reference; or c) i) deactivating the AVC if the angular rotational speed of the rotor and the angular stator frequency multiplied by two is outside the critical range, and ii) controlling the electric motor based on the electrical torque reference.

The electrical torque reference is the driving torque reference for controlling the electric motor and is determined by the requirements for load control. The oscillating incremental torque reference adds a torque component which has the purpose to cancel the unbalance torque of the electric motor, and which results from unwanted vibrations of the motor assembly.

The method may be performed over and over during operation of the electric motor.

According to one embodiment in step c ii) the electric torque reference is the only torque reference used for controlling the electric motor.

According to one embodiment the critical range has a lower endpoint of ωₒ−A and an upper endpoint of ωₒ+B, where ωₒ is the mechanical resonance frequency and both A and B are smaller than a value of the mechanical resonance frequency.

According to one embodiment in step c i) the AVC is deactivated by setting the AVC a damping of the AVC to greater than zero.

According to one embodiment step c i) comprises setting the oscillating incremental torque angular frequency of the AVC to a resonance frequency of the motor assembly.

According to one embodiment in step b iii) the AVC uses feedback of a measured vibration-related signal of the electric motor to obtain the oscillating incremental torque reference.

The feedback may be negative feedback.

The AVC may for example be a resonant controller.

According to one embodiment the vibration-related signal is horizontal vibration velocity.

According to one embodiment the AVC has infinite gain at the oscillating incremental torque angular frequency.

There is according to a second aspect of the present disclosure provided a control system for reducing vibrations in an electric motor comprising a rotor and a stator, the control system comprising: processing circuitry, and a storage medium comprising computer code, which when executed by the processing circuitry is configured to cause the control system to perform the method of the first aspect.

There is according to a third aspect of the present disclosure provided a motor system comprising: an electric motor, a control system of the second aspect configured to control the electric motor.

Generally, all terms used in the claims are to be interpreted according to their ordinary meaning in the technical field, unless explicitly defined otherwise herein. All references to “a/an/the element, apparatus, component, means”, etc. are to be interpreted openly as referring to at least one instance of the element, apparatus, component, means, etc., unless explicitly stated otherwise.

### BRIEF DESCRIPTION OF THE DRAWINGS

Exemplifying embodiments will now be described, with reference to the accompanying drawings, in which:

FIG. 1 schematically shows a motor assembly;

FIG. 2 schematically shows an example of a control system of the motor assembly in FIG. 1;

FIG. 3 is a flowchart of a method of reducing vibrations in the motor assembly; and

FIG. 4 shows some functional blocks of the control system.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

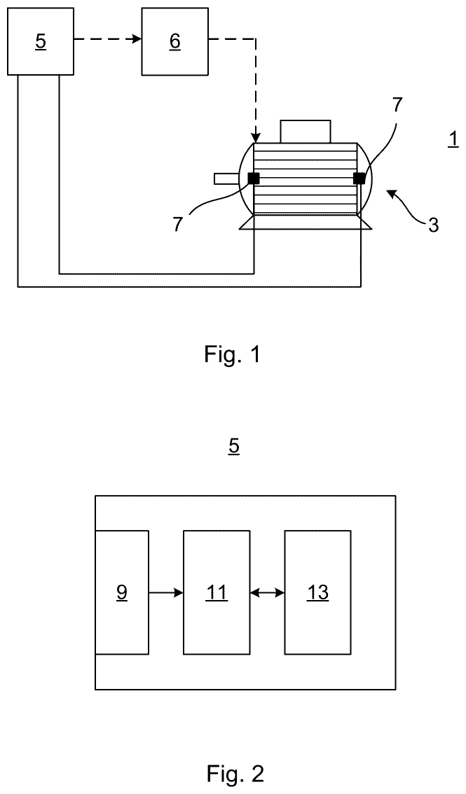

FIG. 1 shows an example of a motor system 1. The motor system 1 comprises a motor assembly including an electric motor 3, the foundation on which the electric motor 3 stands, and the outer cover of the electric motor 3.

The electric motor 3 comprises a stator, and a rotor arranged inside the stator and arranged to rotate relative to the stator.

The motor system 1 also comprises a control system 5, a power converter 6, such as a frequency converter, configured to drive the electric motor 3, and configured to be controlled by the control system 5, and a plurality of sensors 7.

The motor assembly may also include a load which the electric motor 3 is configured to drive.

The sensors 7 are configured to make measurements of a vibration-related parameter such as acceleration, vibrational velocity, displacement, or sound, of the motor system 1. The sensors 7 may thus for example be accelerometers, displacement sensors, or microphones. The sensors 7 may for example be arranged to measure horizontal vibration, such as horizontal acceleration, i.e., acceleration in the horizontal plane.

FIG. 2 schematically depicts a block diagram of an example of the control system 5. The control system 5 is configured to reduce mechanical vibrations of the motor assembly while the electric motor 3 is in operation.

The control system 5 comprises an input unit 9 configured to receive a vibration-related signal based on measurements from the sensors 7.

The control system 5 comprises an AVC. The AVC is configured to determine an oscillating incremental torque reference as a feedback of the vibration-related signal, as will be explained in more detail in the following.

The AVC may be a resonant controller, for example as follows:

$${AVC}^{( s )} = K \frac{s \cdot cos ( {ω}_{r} T ) - {ω}_{r} sin ( {ω}_{r} T )}{{s}^{2} + 2 {ζ}_{r} {ω}_{r} s + {ω}_{r}^{2}} , \qquad ( 1 )$$

where K is the gain, ζᵣ is the damping, ωᵣ is the oscillating incremental torque angular frequency, and T is the time delay of the response of the oscillating incremental torque to its oscillating incremental torque reference.

According to one example, the control system 5 may comprise a signal conditioner which converters the measurements by the sensors 7 to the vibration-related signal. For example, the sensors 7 may be accelerometers, and the signal conditioner may be configured to convert the acceleration to vibrational velocity, which according to an example may be the vibration-related signal.

The control system 5 comprises processing circuitry 11. The processing circuitry 11 may for example use any combination of one or more of a suitable central processing unit (CPU), multiprocessor, microcontroller, digital signal processor (DSP), application specific integrated circuit (ASIC), field programmable gate arrays (FPGA) etc., capable of executing any herein disclosed operations concerning reducing vibrations of the motor system 1.

The control system 5 may comprise a storage medium 13. The storage medium 13 may comprise a computer program including computer code which when executed by the processing circuitry 13 causes the control system 5 to perform a method as disclosed herein.

The storage medium 13 may for example be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory.

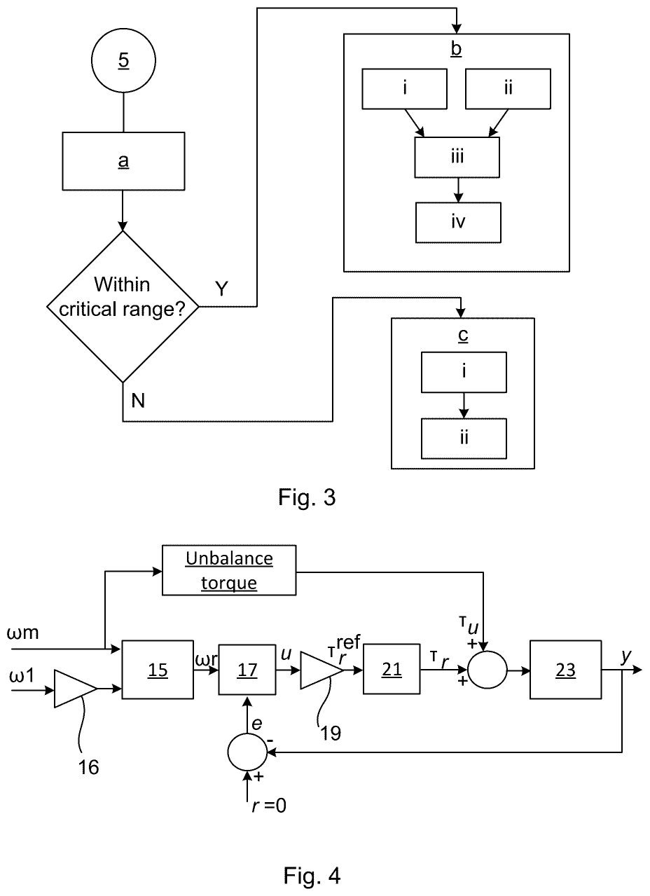

With reference to FIGS. 3 and 4, a method of reducing vibrations in the electric motor 3 by means of the AVC will now be described.

An analysis of the dynamics of horizontal vibration shows that rotor unbalance results in an unbalance torque τᵤ, which excites the horizontal vibrations. The unbalance torque τᵤ is applied to the electric motor 3 in exactly the same way as the electrical torque, which can be controlled by the power converter 6. This makes it feasible to add, via the AVC, an oscillating increment τᵣ to the electrical torque, such that τᵣ=−τᵤ in the steady state, ideally cancelling the excitation of horizontal vibrations.

The angular frequency of the unbalance torque τᵤ is fundamentally the same angular frequency as the angular rotational speed ωₘ of the rotor. This is known as 1X excitation. In addition, for two-pole motors, there is an excitation at the angular stator frequenc ωₗ multiplied by two, called 2F excitation.

In a step a) it is determined whether one of the angular rotational speed ωₘ of the rotor and the angular stator frequency ωₗ multiplied by two is within a critical range comprising a mechanical resonance frequency ωₒ of the motor assembly. In case the electric motor 3 is connected to a load, which may also be part of the motor assembly, the load influences the mechanical resonance frequency.

The critical range may be expressed as

$$CR = [ {ω}_{0} - A , {ω}_{0} + B ) , \qquad ( 2 )$$

A and B are numbers each of which may be smaller than the mechanical resonance frequency ωₒ. A and B may for example be at least one order of magnitude smaller than the mechanical resonance frequency ωₒ. A and B may be equal, in which case the critical range is centred around the mechanical resonance frequency ωₒ.

The angular rotational speed ωₘ may for example be determined by measurement or estimation. The angular stator frequency ωₗ is known from the operation of the control system 5.

In case it is determined in step a) that the angular rotational speed ωₘ of the rotor is within the critical range, in a step b i) the oscillating incremental torque angular frequency ωᵣ of the AVC is set to the angular rotational speed ωₘ of the rotor.

In case it is determined in step a) that the angular stator frequency ωₗ multiplied by two is within the critical range, in a step b ii) the oscillating incremental torque angular frequency ωᵣ of the AVC is set to the angular stator frequency ωₗ multiplied by two.

As shown in FIG. 4, the control system 5 may comprise an AVC input module 15. The AVC input module 15 performs step a) and sets the oscillating incremental torque angular frequency ωᵣ for the AVC 17. Thus, as an example, the AVC input module 15 sets the value of the oscillating incremental torque angular frequency ωᵣ of the AVC 17 according to equation (1) above.

The control system 5 may comprise a multiplication module 16 which multiplies the angular stator frequency ωₗ by two before it is processed by the AVC input module 15.

A control error e of the vibrations is determined as the difference between the vibration-related signal y and a reference r which is zero. Thus, the control error e is zero when no vibrations are measured by the sensors 7. The control error e is input to the AVC 17.

In a step b iii) an oscillating incremental torque reference τᵣ is generated using the AVC 17 with the oscillating incremental torque angular frequency ωᵣ set in step b i) or b ii).

In steps b i) to b iii) the damping ζᵣ of the AVC 17 may be zero to obtain the poles on the imaginary axis at s=±jωᵣ. This gives the effect that a sinusoidal unbalance torque of angular frequency ωᵣ is completely suppressed in the steady state. In other words, the AVC 17 has infinite gain at the oscillating incremental torque angular frequency ωᵣ.

The AVC output u of the AVC 17 is sent to a scaling module 19, which scales the AVC output u by 1/ [symbol] , where [symbol] is an estimate of the resonant gain of the transfer function of a dynamic mechanical motor model describing the motor assembly. The scaling module 19 outputs τ_{ref}=u/ [symbol] , which may be sent to a delay module 21 to attain e^{-sT}·u/ [symbol] , which is the oscillating incremental torque reference τᵣ.

Essentially, the oscillating incremental torque reference τᵣ is AVC(s)*y or AVC(s)*(−y), with the additional scaling and time delay. The oscillating incremental torque reference τᵣ is thus set as feedback of the vibration-related signal y to the AVC 17.

In a step b iv) the electric motor 3 is controlled based on a sum of the oscillating incremental torque reference τᵣ and an electrical torque reference.

Ideally, the oscillating incremental torque reference τᵣ is equal, but with opposite sign, to the unbalance torque τᵤ, i.e., τᵣ=−τᵤ. Thus, the oscillating incremental torque reference τᵣ is used by the power converter 6 and injected into the electric motor 3, in FIG. 4 illustrated by the module 23, which is the transfer function of the dynamic mechanical motor model.

In case neither the angular rotational speed ωₘ nor the angular stator frequency ωₗ multiplied by two is within the critical range, in a step c i) the AVC 17 is deactivated. In this case, in a step c ii) the electric motor 3 is controlled based on the electrical torque reference. Thus, in step c ii) the electric torque reference is the only torque reference used for controlling the electric motor.

The AVC 17 is deactivated by setting the damping ζᵣ of the AVC 17 positive, i.e., ζᵣ>0.

Further, in step c i) the oscillating incremental torque angular frequency ωᵣ of the AVC 17 may be set to the mechanical resonance frequency do.

By performing the method over and over during the operation of the electric motor 3, the mechanical vibrations are well suppressed for both 1X and 2F excitation.

The inventive concept has mainly been described above with reference to a few examples. However, as is readily appreciated by a person skilled in the art, other embodiments than the ones disclosed above are equally possible within the scope of the inventive concept, as defined by the appended claims.

1. A method of reducing vibrations in an electric motor including a rotor and a stator, by means of an active vibration controller, AVC, the method comprising:
a) determining whether one of an angular rotational speed (ωₘ) of the rotor and an angular stator frequency (ωₗ) multiplied by two is within a critical range comprising a mechanical resonance frequency of a motor assembly comprising the electric motor and its load,
b) i) setting an oscillating incremental torque angular frequency (ωᵣ) of the AVC to the angular rotational speed (ωₘ) of the rotor if the angular rotational speed (ωₘ) of the rotor is within the critical range, or
ii) setting the oscillating incremental torque angular frequency (ωᵣ) to the angular stator frequency (ωₗ) multiplied by two if the angular stator frequency (ωₗ) multiplied by two is within the critical range,
iii) generating an oscillating incremental torque reference (τᵣ) using the AVC with the oscillating incremental torque angular frequency (ωᵣ) set in step b i) or b ii), and
iv) controlling the electric motor based on a sum of the oscillating incremental torque reference (τᵣ) and an electrical torque reference; or
c) i) deactivating the AVC if the angular rotational speed (ωₘ) of the rotor and the angular stator frequency (ωₗ) multiplied by two is outside the critical range, and
ii) controlling the electric motor based on the electrical torque reference.

2. The method as claimed in claim 1, wherein in step c ii) the electric torque reference is the only torque reference used for controlling the electric motor.

3. The method as claimed in claim 1, wherein the critical range has a lower endpoint of ωₒ−A and an upper endpoint of ωₒ+B, where ωₒ is the mechanical resonance frequency and both A and B are smaller than a value of the mechanical resonance frequency.

4. The method as claimed in claim 1, wherein in step c i) the AVC is deactivated by setting a damping of the AVC to greater than zero.

5. The method as claimed in claim 1, wherein step c i) comprises setting the oscillating incremental torque angular frequency (ωᵣ) of the AVC to a resonance frequency of the motor assembly.

6. The method as claimed in claim 1, wherein in step b iii) the AVC uses feedback of a measured vibration-related signal (y) of the electric motor to obtain the oscillating incremental torque reference (τᵣ).

7. The method as claimed in claim 6, wherein the vibration-related signal (y) is horizontal vibration velocity.

8. The method as claimed in claim 1, wherein the AVC has infinite gain at the oscillating incremental torque angular frequency (ωᵣ).

9. A control system for reducing vibrations in an electric motor including a rotor and a stator, the control system comprising:
processing circuitry, and
a storage medium comprising computer code, which when executed by the processing circuitry is configured to cause the control system to perform the method including:
a) determining whether one of an angular rotational speed (ωₘ) of the rotor and an angular stator frequency (ωₗ) multiplied by two is within a critical range comprising a mechanical resonance frequency of a motor assembly comprising the electric motor and its load,
b) i) setting an oscillating incremental torque angular frequency (ωᵣ) of the AVC to the angular rotational speed (ωₘ) of the rotor if the angular rotational speed (ωₘ) of the rotor is within the critical range, or
ii) setting the oscillating incremental torque angular frequency (ωᵣ) to the angular stator frequency (ωₗ) multiplied by two if the angular stator frequency (ωₗ) multiplied by two is within the critical range,
iii) generating an oscillating incremental torque reference (τᵣ) using the AVC with the oscillating incremental torque angular frequency (ωᵣ) set in step b i) or b ii), and
iv) controlling the electric motor based on a sum of the oscillating incremental torque reference (τᵣ) and an electrical torque reference; or
c) i) deactivating the AVC if the angular rotational speed (ωₘ) of the rotor and the angular stator frequency (ωₗ) multiplied by two is outside the critical range, and
ii) controlling the electric motor based on the electrical torque reference.

10. A motor system comprising:
an electric motor,
a control system for reducing vibrations in an electric motor including a rotor and a stator, the control system comprising:
having processing circuitry, and
a storage medium comprising computer code, which when executed by the processing circuitry is configured to cause the control system to perform the method including:
a) determining whether one of an angular rotational speed (ωₘ) of the rotor and an angular stator frequency (ωₗ) multiplied by two is within a critical range comprising a mechanical resonance frequency of a motor assembly comprising the electric motor and its load,
b) i) setting an oscillating incremental torque angular frequency (ωᵣ) of the AVC to the angular rotational speed (ωₘ) of the rotor if the angular rotational speed (ωₘ) of the rotor is within the critical range, or
ii) setting the oscillating incremental torque angular frequency (ωᵣ) to the angular stator frequency (ωₗ) multiplied by two if the angular stator frequency (ωₗ) multiplied by two is within the critical range,
iii) generating an oscillating incremental torque reference (τᵣ) using the AVC with the oscillating incremental torque angular frequency (ωᵣ) set in step b i) or b ii), and
iv) controlling the electric motor based on a sum of the oscillating incremental torque reference (τᵣ) and an electrical torque reference; or
c) i) deactivating the AVC if the angular rotational speed (ωₘ) of the rotor and the angular stator frequency (ωₗ) multiplied by two is outside the critical range, and
ii) controlling the electric motor based on the electrical torque reference, and
configured to control the electric motor.

11. The method as claimed in claim 2, wherein the critical range has a lower endpoint of ωₒ−A and an upper endpoint of ωₒ+B, where ωₒ is the mechanical resonance frequency and both A and B are smaller than a value of the mechanical resonance frequency.

12. The method as claimed in claim 2, wherein in step c i) the AVC is deactivated by setting a damping of the AVC to greater than zero.

13. The method as claimed in claim 2, wherein step c i) comprises setting the oscillating incremental torque angular frequency (ωᵣ) of the AVC to a resonance frequency of the motor assembly.

14. The method as claimed in claim 2, wherein in step b iii) the AVC uses feedback of a measured vibration-related signal (y) of the electric motor to obtain the oscillating incremental torque reference (τᵣ).
